(19) United States
(12) Patent Application Publication
(10) Pub. No.: US 2017/0225575 A1
(43) Pub. Date: Aug. 10, 2017

(54) CHARGING DEVICE FOR ELECTRIC MOVING BODY

(71) Applicant: TAKAOKA TOKO CO., LTD., Koto-ku, Tokyo (JP)

(72) Inventors: Masatoshi NORO, Oyama-shi, Tochigi (JP); Yasuhiro NAKANO, Oyama-shi, Tochigi (JP)

(73) Assignee: Takaoka Toko Co., Ltd., Koto-ku, Tokyo (JP)

(21) Appl. No.: 15/502,304

(22) PCT Filed: Sep. 29, 2015
(86) PCT No.: PCT/JP2015/077557

§ 371 Date: Feb. 7, 2017

(30) Foreign Application Priority Data
Oct. 1, 2014 (JP) 2014-202994

(51) Int. Cl. B60L 11/18; H02J 7/00

(52) U.S. Cl. CPC B60L 11/1812; B60L 11/1818; H02J 7/007

(57) ABSTRACT

A charging device is for an electric moving body, which is compatible with multiple charging protocols having different settings for voltage, current. The vehicle charging device is provided with: a CHAdeMO control unit and a combined-charging control unit for performing battery charging control on the basis of the CHAdeMO protocol and the combined-charging protocol; power conversion systems (PCS) which are connected in parallel and convert alternating-current power into direct-current power; power-feeding connectors which connect to a power-receiving connector disposed in the vehicle; and a switching unit for setting a connection between the output of the PCSs and the power-feeding connectors. The switching unit performs settings such that when one vehicle is to be charged, the PCSs are connected to the battery of this vehicle, or when two vehicles are to be charged, the PCSs are respectively connected to the batteries of these vehicles.

### FIELD OF THE INVENTION

The present invention relates to a charging device for electric moving bodies, which is compatible with a plurality of charging protocols.

### BACKGROUND OF THE INVENTION

In recent years, electric vehicles and hybrid vehicles, which have motors, electrical storage devices, and the like to move by electric power, have started becoming widespread. As a fast charging protocol for charging these vehicles, a CHAdeMO (registered trademark) protocol and a Combo (Combined Charging System: CCS) protocol are known, and these protocols differ in the settings for voltage, electric current, and the like. As a fast charger compatible with both of the CHAdeMO protocol and the Combo protocol, there is a product supplied by for example ABB Ltd (see non-patent literature 1).

FIG. 9 is a block diagram of a conventional dual-protocol fast charger compatible with the CHAdeMO protocol and the Combo protocol. The conventional dual-protocol fast charger 1 includes: a control unit 2 that controls the whole device; a display panel 3 that performs setting for various kinds of information and displays them; a CHAdeMO control unit 4 that controls the charging based on the CHAdeMO protocol; a Combo control unit 5 that controls the charging based on the Combo protocol; Power Conversion Systems (PCSs) 6 and 7 that convert alternating-current power into direct-current power; a charging connector 8 based on the CHAdeMO protocol; and a charging connector 9 based on the Combo protocol.

With this configuration, the conventional dual-protocol fast charger 1 can rapidly charge two electric vehicles simultaneously, which are compatible with the CHAdeMO protocol and the Combo protocol, respectively.

### CITATION LIST

### Non-Patent Literature

[Non-PTL 1] “One fast charger supporting all charging standards”, [online], ABB Ltd. [searched on Sep. 24, 2014], Internet <URL: http://www.abb.com/product/us/9aac175242.aspx>

### SUMMARY OF THE INVENTION

### Technical Problem

However, the conventional dual-protocol fast charger 1 has a problem in that: two fast chargers based on the respective protocols are disposed in one housing, leading to a large-scaled housing, and thus the installation space cannot be reduced.

The present invention has been made for solving the conventional problem, and the object of the invention is to provide a charging device for electric moving bodies, which is compatible with a plurality of charging protocols having different settings for voltage, electric current, and the like and which can achieve the reduction of the installation space.

### Solution to Problem

The charging device of the invention is a charging device for electric moving bodies, which converts inputted alternating-current power into prescribed direct-current power and charges batteries disposed in the electric moving bodies through power-receiving connectors provided in the electric moving bodies, the charging device comprising: a charging control unit that performs charging control of the batteries on the basis of at least one of a CHAdeMO charging protocol and a Combo charging protocol;

a plurality of power conversion units connected to each other in parallel, each of the power conversion units converting the alternating-current power into the direct-current power to output predetermined output power under the charging control; a plurality of power-feeding connectors that are connected to the power-receiving connectors when power is fed to the batteries; and a connection setting unit that sets connections between outputs of the power conversion units and the power-feeding connectors on the basis of a number of the electric moving bodies; wherein: if the number of the electric moving bodies is one, the connection setting unit sets the connections in such a way that total output power of each output power of the power conversion units is outputted to a battery disposed in the electric moving body; if the number of the electric moving bodies is more than one, the connection setting unit sets the connections in such a way that the total output power is divided to output the divided power to each of the batteries disposed in the electric moving bodies; and if, during charging of one battery disposed in an electric moving body capable of being charged based on one of the CHAdeMO charging protocol and the Combo charging protocol, another battery disposed in another electric moving body capable of being charged based on the CHAdeMO charging protocol or the Combo charging protocol is charged, the connection setting unit sets the connections in such a way that the one battery and the another battery are charged keeping a charging state of the one battery.

### Advantageous Effects of Invention

With the invention, it is possible to provide a charging device for electric moving bodies, which has advantageous effects that the charging device is compatible with a plurality of charging protocols having different settings for voltage, electric current, and the like and that the installation space can be reduced.

### BRIEF DESCRIPTION OF THE DRAWINGS

FIG. 1 A block diagram shows a vehicle charging device according to a first embodiment of the present invention.

FIG. 2A A diagram illustrates functions of a control unit and a switching unit of the vehicle charging device according to the first embodiment of the present invention, and shows a case where a vehicle to be charged is one CHAdeMO vehicle.

FIG. 2B A diagram illustrates functions of the control unit and the switching unit of the vehicle charging device according to the first embodiment of the present invention, and shows a case where a vehicle to be charged is one Combo vehicle.

FIG. 2C A diagram illustrates functions of the control unit and the switching unit of the vehicle charging device according to the first embodiment of the present invention, and shows a case where vehicles to be charged are one CHAdeMO vehicle and one Combo vehicle.

FIG. 3 A diagram illustrates an example of a charging pattern in a case where only one CHAdeMO vehicle is charged by the vehicle charging device according to the first embodiment of the present invention.

FIG. 4 A diagram illustrates an example of a charging pattern in a case where one CHAdeMO vehicle and one Combo vehicle are charged in parallel from the same time by the vehicle charging device according to the first embodiment of the invention.

FIG. 5 A diagram illustrates an example of a first charging pattern in a case where charging of only a CHAdeMO vehicle is first started, and during its charging, charging of a Combo vehicle is started, in the vehicle charging device according to the first embodiment of the invention.

FIG. 6 A diagram illustrates an example of a second charging pattern in a case where charging of only a CHAdeMO vehicle is started, and during its charging, charging of a Combo vehicle is started, in the vehicle charging device according to the first embodiment of the invention.

FIG. 7 A flowchart explains operations of the vehicle charging device according to the first embodiment of the invention.

FIG. 8 A block diagram illustrates a vehicle charging device according to a second embodiment of the present invention.

FIG. 9 A block diagram illustrates a conventional dual-protocol fast charger.

### DETAILED DESCRIPTION OF THE INVENTION

Embodiments of the present invention will be described below with reference to drawings. In addition, although in the following embodiments, a vehicle charging device for charging electric vehicles will be explained as an example, the present invention should not be limited to the example. The invention can be also applied to a moving body such as motor bicycle and boat, which are driven by electric driving sources.

### First Embodiment

First, the configuration of a vehicle charging device according to the first embodiment of the invention will be described.

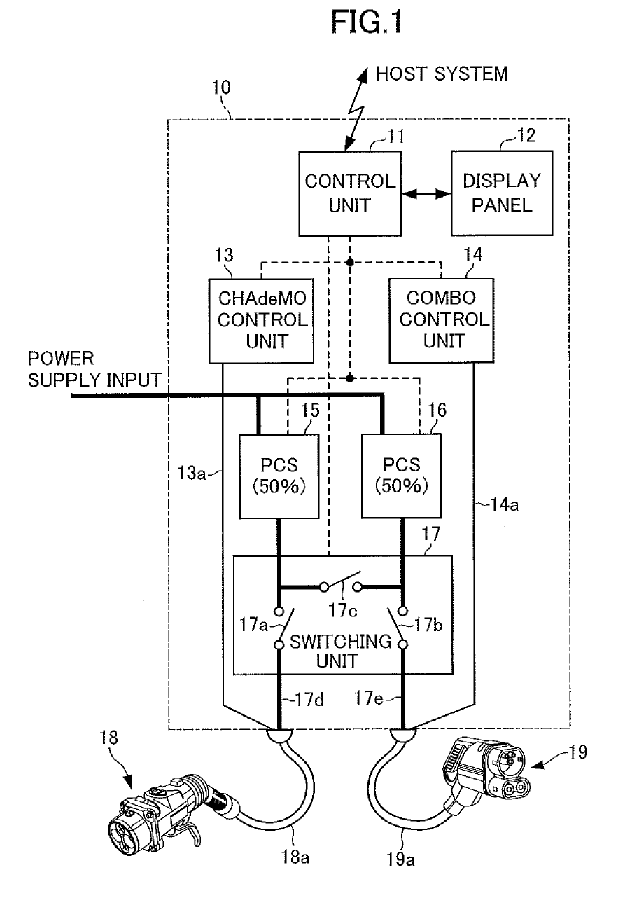

As shown in FIG. 1, the vehicle charging device 10 of the embodiment includes a control unit 11, a display panel 12, a CHAdeMO control unit 13, a Combo control unit 14, PCSs (Power Conversion Systems) 15 and 16, a switching unit 17, and power-feeding connectors 18 and 19. In addition, the vehicle charging device 10 composes a charging device for electric moving bodies according to the present invention.

This vehicle charging device 10 includes a microcomputer that has a Central Processing Unit (CPU), a Read Only Memory (ROM), a Random Access Memory (RAM), an input/output circuit connected to various interfaces, and the like, which are not shown. The vehicle charging device 10 causes the microcomputer to function as functional parts of the control unit 11, the display panel 12, the CHAdeMO control unit 13, the Combo control unit 14, the PCSs 15, 16, the switching unit 17 and the power-feeding connectors 18, 19, by executing a control program pre-stored in the ROM.

The control unit 11 controls various parts of the vehicle charging device 10, and performs communication with a host system such as a server device and an accounting system, which are connected to the vehicle charging device 10.

The display panel 12 includes, for example, a touch panel into which a user inputs prescribed kinds of information, and a display unit that displays various kinds of information. For instance, information about a charging protocol or accounting is inputted into the display panel 12 through the operation by the user.

The CHAdeMO control unit 13 performs charging control on the basis of a standard of the CHAdeMO protocol. Specifically, the CHAdeMO control unit 13 is connected to a CHAdeMO communication line 13a for communicating with a vehicle, and the CHAdeMO control unit 13 performs the charging control by sending to or receiving from the vehicle to be charged based on the CHAdeMO protocol (hereinafter referred to as “CHAdeMO vehicle”) a control signal relating to battery charging through the CHAdeMO communication line 13a. In addition, the CHAdeMO control unit 13 composes the charging control unit of the present invention.

The Combo control unit 14 performs charging control on the basis of a standard of the Combo protocol. Specifically, the Combo control unit 14 is connected to a Combo communication line 14a for communicating with a vehicle, and the Combo control unit 14 performs the charging control by sending to or receiving from the vehicle to be charged based on the Combo protocol (hereinafter referred to as “Combo vehicle”) a control signal relating to battery charging through the Combo communication line 14a. In addition, the Combo control unit 14 composes the charging control unit of the present invention.

The PCS 15 is connected in parallel with the PCS 16, and converts inputted alternating-current power to direct-current power to output predetermined output power to the battery of the vehicle through the switching unit 17. This PCS 15 composes the power conversion unit of the present invention.

The PCS 16 is connected in parallel with the PCS 15, and converts the inputted alternating-current power to direct-current power to output predetermined output power to the battery of the vehicle through the switching unit 17. This PCS 16 composes the power conversion unit of the present invention.

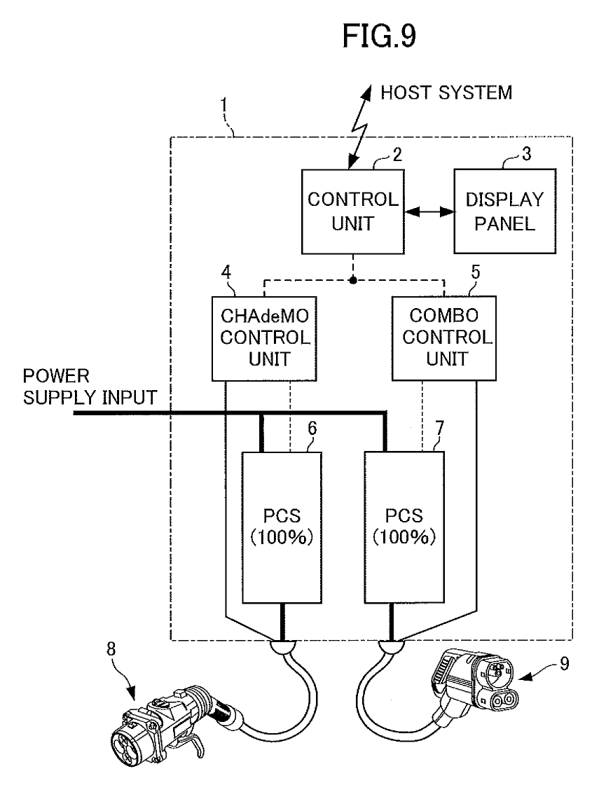

In FIG. 1, “50%” in parentheses shown in PCSs 15 and 16 means that each output power capable of being outputted by the PCSs 15 and 16 is 50% of maximum output power of the vehicle charging device 10 (hereinafter referred to as “device maximum output power”). For instance, if the device maximum output power is 50 kW, the PCSs 15 and 16 can each output power of 25 kW. In contrast, the conventional PCSs 6 and 7 shown in FIG. 9 can each output 100% power of the device maximum output power. Hereafter, in the embodiment, an explanation will be made on the assumption that the device maximum output power is 50 kW and each output power capable of being outputted by the PCSs 15 and 16 is 25 kW.

Since the output power capable of being outputted by each of the PCSs 15 and 16 is 25 kW, the mounting space of the PCSs in a housing can be reduced more than the conventional PCSs 6 and 7 each capable of outputting power of 50 kW. Accordingly, with the vehicle charging device 10 having the PCSs 15 and 16, it is possible to make the size of the housing compact, and thus its installation space can be reduced.

The switching unit 17 includes three switches 17a to 17c, which perform on-off actions based on the control signal from the control unit 11. Moreover, the switching unit 17 is connected to the power-feeding connectors 18 and 19 through power lines 17d and 17e, respectively. In addition, the switching unit 17 composes the connection setting unit of the present invention.

The power-feeding connector 18 is a connector to be connected to a power-receiving connector provided in the CHAdeMO vehicle. This power-feeding connector 18 is connected to a body of the vehicle charging device 10 through a cable 18a having the CHAdeMO communication line 13a and the power line 17d.

The power-feeding connector 19 is a connector to be connected to a power-receiving connector provided in the Combo vehicle. This power-feeding connector 19 is connected to the body of the vehicle charging device 10 through a cable 19a having the Combo communication line 14a and the power line 17e.

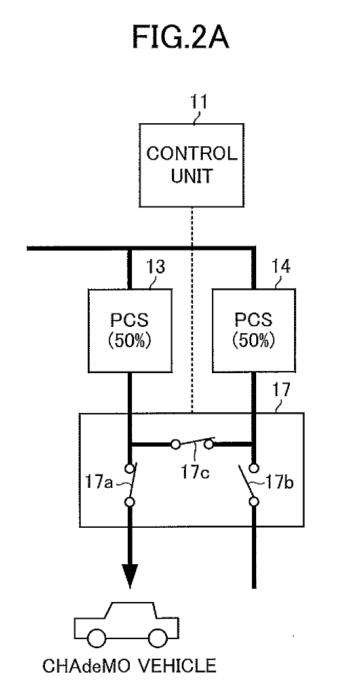

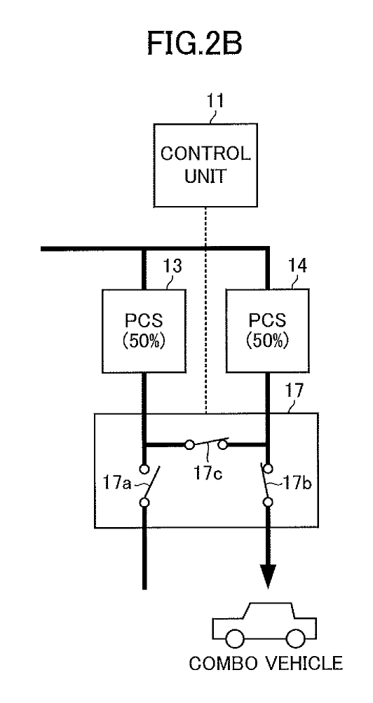

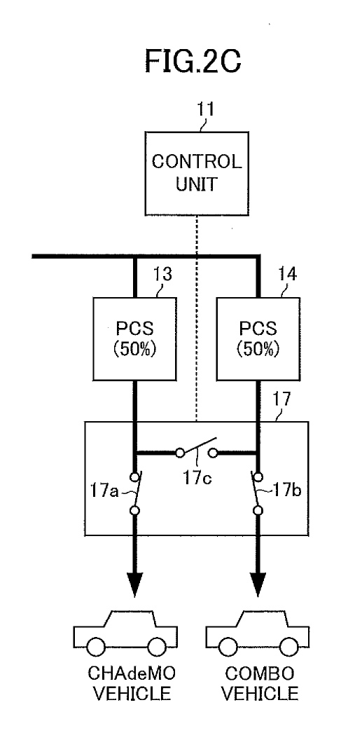

Next, functions of the control unit 11 and the switching unit 17 will be described with reference to FIGS. 2A to 2C.

FIGS. 2A to 2C are diagrams illustrating an ON or OFF state of each of the switches included in the switching unit 17, in a case where a vehicle to be charged by the vehicle charging device 10 is one CHAdeMO vehicle, in a case where a vehicle to be charged is one Combo vehicle, and in a case where vehicles to be charged are one CHAdeMO vehicle and one Combo vehicle, respectively.

First, in the case of one CHAdeMO vehicle as shown in FIG. 2A, the control unit 11 sends a control signal to the switching unit 17 so as to turn on the switches 17a and 17c and turn off the switch 17b. As a result, it is possible to output the total power of each output power of the PCSs 15 and 16, namely output power (50 kW) equal to 100% of the device maximum output power for the battery disposed in the CHAdeMO vehicle.

Next, in the case of one Combo vehicle as shown in FIG. 2B, the control unit 11 sends a control signal to the switching unit 17 so as to turn on the switches 17b and 17c and turn off the switch 17a. As a result, it is possible to output the total power of each output power of the PCSs 15 and 16, namely output power (50 kW) equal to 100% of the device maximum output power for the battery disposed in the Combo vehicle.

Next, in the case of one CHAdeMO vehicle and one Combo vehicle as shown in FIG. 2C, the control unit 11 sends a control signal to the switching unit 17 so as to turn on the switches 17a and 17b and turn off the switch 17c. As a result, the output power of the PCS 15 is outputted to the battery disposed in the CHAdeMO vehicle, and the output power of the PCS 16 is outputted to the battery disposed in the Combo vehicle. That is to say, it is possible to output the output power equal to 50% of the device maximum output power for each of the batteries disposed in the CHAdeMO vehicle and the Combo vehicle, namely for each charging protocol. In this case, the total output power of the PCSs 15 and 16 is distributed to the batteries based on each of the CHAdeMO and Combo charging protocols so as to charge each battery with the power equal to or less than 50% of the device maximum output power.

In addition, although it has been described that in the embodiment each output power capable of being outputted by the PCSs 15 and 16 is equal to 50% of the device maximum output power, the invention should not be limited to this. For example, the output power capable of being outputted by the PCSs 15 and 16 may be 60% and 40%, respectively, of the device maximum output power.

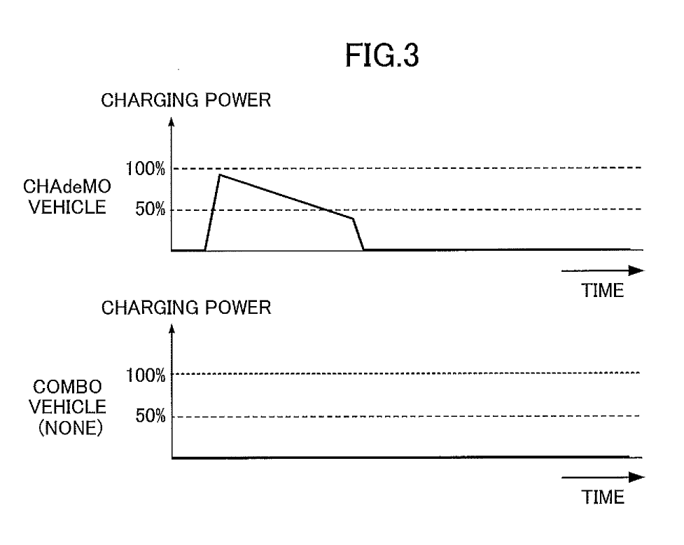

Next, examples of charging patterns of the vehicle charging device 10 in the embodiment will be described with reference to FIGS. 3 to 6. FIGS. 3 to 6 are diagrams illustrating the examples of charging patterns of the vehicle charging device 10 for the CHAdeMO vehicle and the Combo vehicle. Hereafter, charging of the battery of the CHAdeMO vehicle is simply referred to as “charging of the CHAdeMO vehicle”, and charging of the battery of the Combo vehicle is simply referred to as “charging of the Combo vehicle”.

FIG. 3 illustrates an example of charging pattern when only a CHAdeMO vehicle is charged by the vehicle charging device 10. In this case, the vehicle charging device 10 exclusively charges only the CHAdeMO vehicle using the PCSs 15 and 16. This charging is full charging using 100% of the device maximum output power.

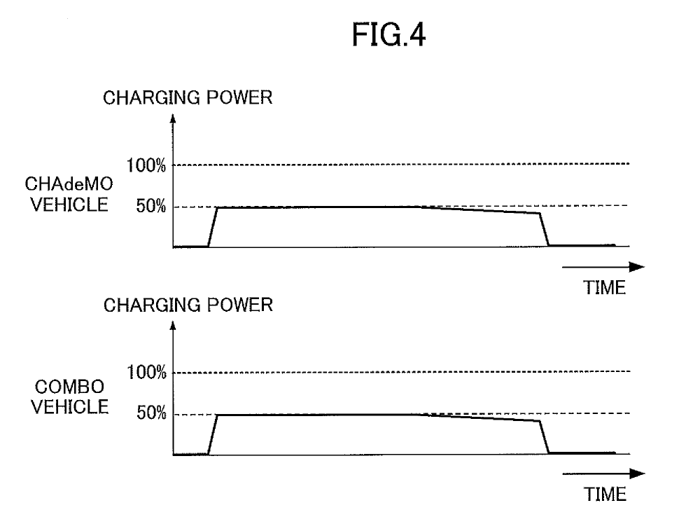

FIG. 4 illustrates an example of charging pattern when a CHAdeMO vehicle and a Combo vehicle are charged in parallel from the same time by the vehicle charging device 10. In this case, the vehicle charging device 10 charges the CHAdeMO vehicle using the PCS 15 and charges the Combo vehicle using the PCS 16. This charging is half charging in which the device maximum output power is divided fifty-fifty.

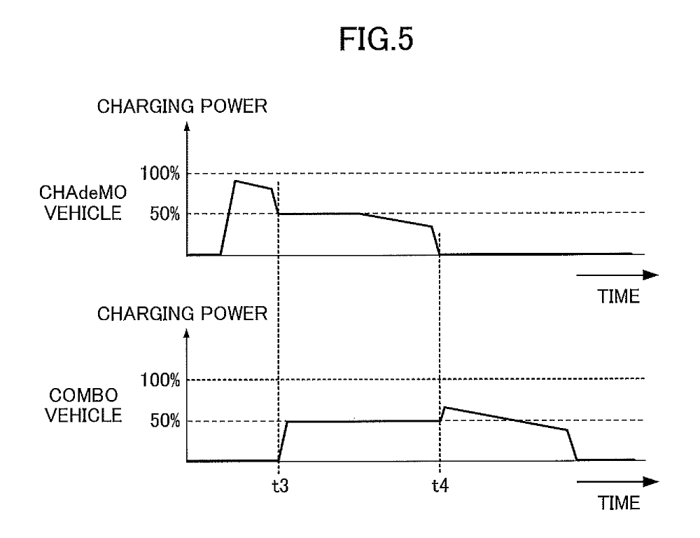

FIG. 5 illustrates a first example of charging pattern in a case where the vehicle charging device 10 first starts charging only for the CHAdeMO vehicle, and during the charging, starts charging for the Combo vehicle. That is, as shown in FIG. 5, when the vehicle charging device 10 starts the charging of the Combo vehicle while charging the CHAdeMO vehicle using the PCSs 15 and 16, the vehicle charging device 10 moves to a condition where only the CHAdeMO vehicle is exclusively charged by the PCS 15 before a starting time t3 of charging the Combo vehicle. From the time t3 to a finishing time t4 of charging the CHAdeMO vehicle, the vehicle charging device 10 charges in parallel the CHAdeMO vehicle using the PCS 15 and the Combo vehicle using the PCS 16. Moreover, the vehicle charging device 10 exclusively charges only the Combo vehicle using the PCSs 15 and 16 after the time t4.

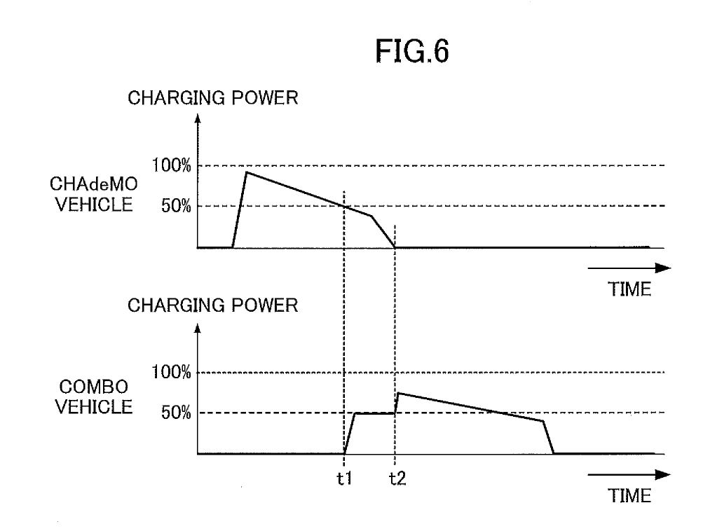

FIG. 6 illustrates a second example of charging pattern in the case where the vehicle charging device 10 first starts charging only for the CHAdeMO vehicle, and during the charging, starts charging for the Combo vehicle. That is, as shown in FIG. 6, from a start of charging the CHAdeMO vehicle to a time t1 when the charging power becomes 50% of the device maximum output power, the vehicle charging device 10 charges only the CHAdeMO vehicle using the PCSs 15 and 16. Moreover, from the time t1 to a finishing time t2 of charging the CHAdeMO vehicle, the vehicle charging device 10 charges in parallel the CHAdeMO vehicle using the PCS 15 and the Combo vehicle using the PCS 16. Further, the vehicle charging device 10 exclusively charges only the Combo vehicle using the PCSs 15 and 16 on and after the time t2.

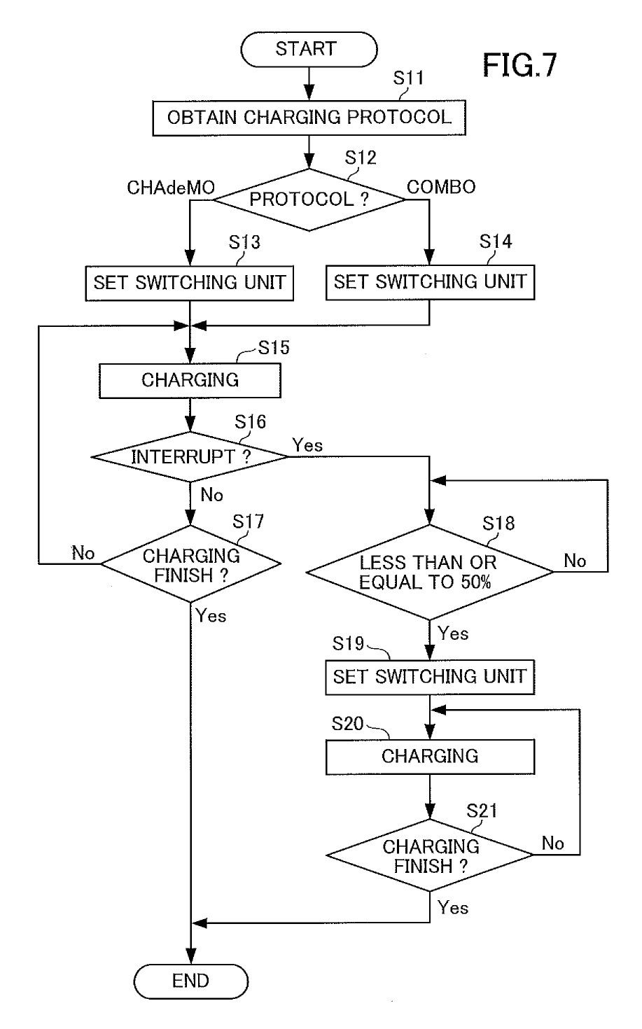

Next, the operation of the vehicle charging device 10 in the embodiment will be explained with reference to FIG. 7. It should be noted that this explanation of the operation relates to the example of the charging pattern as shown in FIG. 6.

The control unit 11 obtains information on the charging protocol, inputted by a user through operation of the display panel 12 (step S11).

The control unit 11 determines from the obtained information whether the charging protocol is a CHAdeMO protocol or a Combo protocol (step S12).

In step S12, when the control unit 11 determines from the obtained information that the charging protocol is a CHAdeMO protocol, the control unit 11 sets the switching unit 17 to a condition in which the CHAdeMO vehicle is fully charged (step S13). Specifically, as shown in FIG. 2A, the control unit 11 turns on the switches 17a and 17c and turns off the switch 17b in the switching unit 17.

On the other hand, in step S12, when the control unit 11 determines from the obtained information that the charging protocol is a Combo protocol, the control unit 11 sets the switching unit 17 to a condition in which the Combo vehicle is fully charged (step S14). Specifically, as shown in FIG. 2B, the control unit 11 turns on the switches 17b and 17c and turns off the switch 17a in the switching unit 17.

Hereafter, explanation will be given supposing that in step S12 the control unit 11 determines that the charging protocol is a CHAdeMO protocol.

After step S13 or S14, the control unit 11 controls the CHAdeMO control unit 13 and the PCSs 15 and 16 to start charging the CHAdeMO vehicle (step S15).

The control unit 11 determines whether or not there is a charging request (shown as “interrupt” in FIG. 7) for a second vehicle (assume a Combo vehicle), given by another user's operation of the display panel 12 (step S16).

If in step S16 the control unit 11 does not determine that there is a charging request for the second vehicle, then the control unit 11 determines whether or not the charging of the CHAdeMO vehicle has finished (step S17).

If in step S17 the control unit 11 determines that the charging has finished, the control unit 11 finishes the process; on the other hand, if the control unit 11 does not determine that the charging has finished, the process returns to step S15 and the control unit 11 executes the process thereafter.

If in step S16 the control unit 11 determines that there is a charging request for the second vehicle, then the control unit 11 determines whether or not the charging power of the CHAdeMO vehicle is equal to or less than 50% of the device maximum output power (step S18). In addition, information on the charging power of the CHAdeMO vehicle is obtained by the CHAdeMO control unit 13 from the CHAdeMO vehicle through the CHAdeMO communication line 13a.

If in step S18 the control unit 11 does not determine that the charging power of the CHAdeMO vehicle is equal to or less than 50%, the control unit 11 repeats the process of step S18. That is, the control unit 11 waits until the charging power of the CHAdeMO vehicle becomes equal to or less than 50%.

On the other hand, if in step S18 the control unit 11 determines that the charging power of the CHAdeMO vehicle is equal to or less than 50%, the control unit 11 sets the switching unit 17 to a condition where the CHAdeMO vehicle and the Combo vehicle are charged (step S19). Specifically, as shown in FIG. 2C, the control unit 11 turns on the switches 17a and 17b and turns off the switch 17c in the switching unit 17.

The control unit 11 controls the CHAdeMO control unit 13, the Combo control unit 14, and the PCSs 15 and 16 to start charging the CHAdeMO vehicle and the Combo vehicle (step S20).

The control unit 11 determines whether or not the charging for both of the CHAdeMO vehicle and the Combo vehicle, or one of them has finished (step S21). If the control unit 11 determines that the charging of both of the CHAdeMO vehicle and the Combo vehicle has finished, the control unit 11 finishes the process. Moreover, if the control unit 11 determines that the charging of one of the CHAdeMO vehicle and the Combo vehicle has finished, the process returns to step S20 to continue the charging only for one vehicle for which charging has not finished.

In addition, in the case of the example of the charging pattern shown in FIG. 5, it is preferable that the order of the step S18 and the step S19 in FIG. 7 is changed; that is, first in a step corresponding to the step S19, the control unit 11 sets the switching unit 17 to a condition where the CHAdeMO vehicle and the Combo vehicle are charged, and then in a step corresponding to the step S18, the control unit 11 determines whether or not the charging of the CHAdeMO vehicle has finished.

As stated above, since the vehicle charging device 10 in the embodiment includes two PCSs which can be smaller than two PCSs provided in a conventional dual-protocol fast charger, the size of the housing can be reduced and the vehicle charging device 10 is compatible with two kinds of charging protocols having different settings for voltage, electric current and the like.

Consequently, the vehicle charging device 10 of the embodiment is compatible with a plurality of charging protocols having different settings for voltage, electric current and the like, and the installation space can be reduced.

Moreover, since the vehicle charging device 10 of the embodiment includes two PCSs each outputting power less than conventional ones, the cost can also be reduced.

In addition, although in the above-stated embodiment, explanation has been made with an example that PSCs 15 and 16 are used when one vehicle is to be charged, the vehicle charging device 10 may be configured to grasp a charging state of the battery through communication with the vehicle and use one of the PCSs 15 and 16 according to the charging state of the battery.

Moreover, although in the above-stated embodiment, explanation has been made with an example that the vehicle charging device 10 has two parallel-connected PCSs 15 and 16 as power conversion system, the invention should not be limited to this example. For instance, in a case of a vehicle charging device having three parallel-connected PCSs, a total output power of these three PCSs may be considered as the device maximum output power in such a way that: when one vehicle is charged, these three PCSs are used; and when two vehicles are charged, for example, two PCSs are used for one vehicle and one PCS is used for the other vehicle. With this configuration, the similar effects to those stated above can be obtained.

Moreover, although in the above-stated embodiment, explanation has been made with an example that the vehicle charging device 10 is compatible with the CHAdeMO protocol and the Combo protocol, the invention should not be limited to this example. The vehicle charging device may be configured to be compatible with only one charging protocol using two PCSs 15 and 16. For instance, another CHAdeMO control unit 13 may be provided in the vehicle charging device 10 instead of the Combo control unit 14 shown in FIG. 1 so as to charge two CHAdeMO vehicles using these two CHAdeMO control units 13, two CHAdeMO communication lines 13a, and the PCSs 15 and 16. With this configuration, the similar effects to those stated above can be obtained. Moreover, even in other configuration in which three or more charging protocols are used, the similar effects to those stated above can be obtained

### Second Embodiment

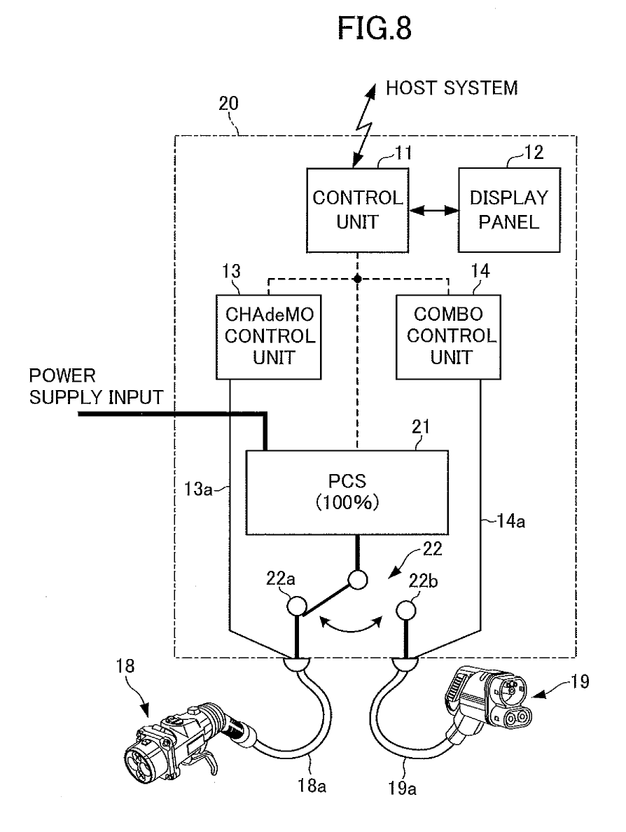

As shown in FIG. 8, the vehicle charging device 20 in the embodiment includes the control unit 11, the display panel 12, the CHAdeMO control unit 13, the Combo control unit 14, a PCS 21, a switching unit 22, and the power-feeding connectors 18 and 19. In addition, explanation about the similar elements to those of the first embodiment will be omitted below.

The PCS 21 can output 100% of the device maximum output power to a CHAdeMO protocol vehicle or a Combo protocol vehicle.

The switching unit 22 has contacts 22a and 22b, and selects one of the contacts 22a and 22b according to a control signal from the control unit 11. In the embodiment, the switching unit 22 selects the contact 22a when the CHAdeMO vehicle is charged, and selects the contact 22b when the Combo vehicle is charged. It should be noted that the switching unit 22 composes the connection setting unit of the present invention.

Since the vehicle charging device 20 of the embodiment is configured as stated above, the control unit 11 can make the switching unit 22 select the contact 22a to fully charge the CHAdeMO vehicle, and make the switching unit 22 select the contact 22b to fully charge the Combo vehicle, by sending the control signal to the switching unit 22.

Moreover, since the vehicle charging device 20 of the embodiment has only one PCS 21 capable of outputting 100% of the device maximum output power, the size of the housing can be reduced more than the conventional charger having two PCSs each capable of outputting 100% of the device maximum output power (see FIG. 9) and the vehicle charging device 20 is compatible with two kinds of charging protocols having different settings for voltage, electric current and the like.

Consequently, the vehicle charging device 20 of the embodiment is compatible with a plurality of charging protocols having different settings for voltage, electric current and the like, and the installation space can be reduced.

Moreover, since the vehicle charging device 20 of the embodiment includes only one PCS 21 capable of outputting 100% of the device maximum output power, the cost can be also reduced more than the conventional charger having two PCSs each capable of outputting 100% of the device maximum output power.

In addition, although in the above-stated embodiment, explanation has been made with an example that the vehicle charging device 20 is compatible with the CHAdeMO protocol and the Combo protocol, the invention should not be limited to this example. For instance, the switching unit 22 may have three contacts so that the vehicle charging device 20 can be applied to three charging protocols, which leads to the similar effects to those as stated above.

### INDUSTRIAL APPLICABILITY

As stated above, the charging device for electric moving bodies according to the invention has advantageous effects that the charging device is compatible with a plurality of charging protocols having different settings of voltage, electric current and the like and that the installation space can be reduced, and thus the invention is useful as a charging device for electric moving bodies, which is compatible with a plurality of charging protocols.

### REFERENCE SIGNS LIST

10, 20: Vehicle charging device (Charging device for electric moving bodies)
11: Control unit
12: Display panel
13: CHAdeMO control unit (Charging control unit)
14: Combo control unit (Charging control unit)
15, 16, 21: PCS (Power Conversion system)
17: Switching unit (Connection setting unit)
17a, 17b, 17c: Switch
18, 19: Power-feeding connector
18a, 19a: Cable
22: Switching unit (Connection setting unit)
22a, 22b: Contact

1. A charging device for electric moving bodies, which converts inputted alternating-current power into prescribed direct-current power and charges batteries disposed in the electric moving bodies through power-receiving connectors provided in the electric moving bodies, the charging device comprising:
a charging control unit that performs a charging control of the batteries on the basis of a CHAdeMO charging protocol and a Combo charging protocol;
a plurality of power conversion units connected to each other in parallel, each of the power conversion units converting the alternating-current power into the direct-current power to output predetermined output power under the charging control;
a plurality of power-feeding connectors that are connected to the power-receiving connectors when power is fed to the batteries; and
a connection setting unit that sets connections between outputs of the power conversion units and the power-feeding connectors on the basis of a number of the electric moving bodies;
wherein: if the number of the electric moving bodies is one, the connection setting unit sets the connections in such a way that total output power of each output power of the power conversion units is outputted to a battery disposed in the electric moving body;
if the number of the electric moving bodies is more than one, the connection setting unit sets the connections in such a way that the total output power is divided to output the divided power to each of the batteries disposed in the electric moving bodies; and
if, during charging of one battery disposed in the electric moving body capable of being charged based on one of the CHAdeMO charging protocol and the Combo charging protocol, another battery disposed in another electric moving body capable of being charged based on other one of the CHAdeMO charging protocol and the Combo charging protocol is charged, the connection setting unit sets the connections in such a way that the one battery and the another battery are charged keeping a charging state of the one battery, and
wherein said each output power capable of being outputted by the power conversion units is predetermined at a prescribed ratio on a basis of maximum output power of the charging device for the electric moving bodies, and
wherein if said another battery is charged during the charging of the one battery: (a) only the one battery is charged with the total output power from a start of charging of the one battery to a start of charging of said another battery, and then, the one battery is charged in parallel with the another battery while power is supplied to the one battery from one of the power conversion units; or (b) when charging power of the one battery reaches a predetermined value by charging with the total output power, the one battery is charged in parallel with the another battery while power is supplied to the one battery from one of the power conversion units; and after (a) or (b), when the charging of the one battery is finished, the another battery is charged with the total output power.

2. (canceled)

3. The charging device for the electric moving bodies according to claim 1, wherein the plurality of power conversion units includes two power conversion units; and only when one battery is charged, the one battery is charged using the two power conversion units; and when two batteries are charged simultaneously, one of the two batteries is charged using one of the two power conversion units while other one of the two batteries is charged using other one of the two power conversion units.

4. The charging device for the electric moving bodies according to claim 1, wherein the plurality of power conversion units includes three power conversion units; and only when one battery is charged, the one battery is charged using the three power conversion units; and when two batteries are charged simultaneously, one of the two batteries is charged using two of the three power conversion units while other one of the two batteries is charged using remaining one of the three power conversion units.
